(19) United States
(12) Patent Application Publication
(10) Pub. No.: US 2026/0141535 A1
(43) Pub. Date: May 21, 2026

(54) REGULATION METHODS AND TRACKING METHODS, SYSTEMS, DEVICES, AND STORAGE MEDIA

(71) Applicant: QUALCOMM Incorporated, San Diego, CA (US)

(72) Inventors: Wentao MAO, Beijing (CN); Zhaohui ZHANG, Beijing (CN); Xu ZHANG, Beijing (CN); Wenjie MOU, San Diego, CA (US)

(21) Appl. No.: 19/125,288

(22) PCT Filed: Dec. 15, 2023
(86) PCT No.: PCT/CN2023/139274

§ 371 Date: Apr. 28, 2025

(30) Foreign Application Priority Data
Dec. 16, 2022 (CN) 202211637340.6

(51) Int. Cl. G06T 7/20; G06F 3/03; G06T 7/70

(52) U.S. Cl. CPC G06T 7/20; G06F 3/0304; G06T 7/70

(57) ABSTRACT

A control method and system, a tracking method and system, a device, and a storage medium are provided. The control method includes: acquiring, using a detector (200), an image of a movable device (100) at a current frame time, the movable device (100) being equipped with a plurality of light output units (110) for outputting signal light (S1); predicting, based on the image, a motion state of the movable device (100) at a next frame time (S2); and obtaining, based on the motion state of the movable device (100) at the next frame time, configuration information of a light output state of each of the light output units (110) at the next frame time, to control the light output unit (110) (S3). The present invention is conductive to adaptively adjusting the light output states of all the light output units (110) based on a real-time state of the movable device (100), which facilitates the light output units (110) to achieve accurate and low-power light output states to ensure the use accuracy of the movable device (100) and reduce the power consumption of the movable device (100).

### TECHNICAL FIELD

Embodiments of the present invention relate to the technical field of pose tracking, and in particular, to regulation methods and tracking methods, systems, devices, and storage media.

### BACKGROUND

A Virtual Reality (VR)/Augmented Reality (AR)/Mixed Reality (MR) technology can provide a simulated three-dimensional digital experience, allowing people to experience any virtual or real world in an immersive manner without being constrained by an actual location where people are in. A 6-Degree of Freedom (6DoF) handheld controller is an important means for implementing human-computer interactions in a VR device. With the development of the technical field of VR, head-mounted 6DoF all-in-one machines have gradually become a mainstream, and the 6DoF handheld controller has gradually become a standard configuration for the head-mounted 6DoF all-in-one machine.

According to types, sensors used in the 6DoF handheld controller can be classified into optical, electromagnetic, and ultrasonic sensors. A main principle of tracking the 6DoF handheld controller is to use a camera to detect infrared spots on the handheld controller, and then use a visual algorithm to calculate a 6DoF pose of the handheld controller. The optical handheld controller has become one of the mainstream implementation methods due to its high positioning accuracy, high tracking robustness, and good user experience.

However, at present, there is usually a trade-off between the positioning accuracy of the handheld controller and the device power consumption.

### SUMMARY

To solve the problems, the embodiments of the present invention provide a control method and system, a tracking method and system, a device, and a storage medium, which are conductive to ensuring the use accuracy of a movable device and reducing the power consumption of the movable device.

In order to solve the above problems, the embodiments of the present invention provide a control method for a light output unit of a movable device, including: acquiring, using a detector, an image of a movable device at a current frame time, the movable device being equipped with a plurality of light output units for outputting signal light; predicting, based on the image, a motion state of the movable device at a next frame time; and obtaining, based on the motion state of the movable device at the next frame time, configuration information of a light output state of each of the light output units at the next frame time, to control the light output unit.

Correspondingly, the embodiments of the present invention further provide a tracking method for a movable device. The movable device is equipped with a plurality of light output units for outputting signal lights. The tracking method includes: obtaining configuration information of a light output state of each of the light output units using any control method provided by the embodiments of the present invention; and adjusting the light output state of each of the light output units based on the configuration information of the light output state.

Correspondingly, the embodiments of the present invention further provide a control system for a light output unit of a movable device, including: an image acquisition unit for acquiring, using a detector, an image of a movable device at a current frame time, wherein the movable device is equipped with a plurality of light output units for outputting signal light; a prediction unit for predicting, based on the image, a motion state of the movable device at a next frame time; a configuration information obtaining unit for obtaining, based on the motion state of the movable device at the next frame time, configuration information of a light output state of each of the light output units at the next frame time, to control the light output unit.

Correspondingly, the embodiments of the present invention further provide a tracking system for a movable device. The movable device is equipped with a plurality of light output units for outputting signal light, and the tracking system includes: a calculation processing module for obtaining configuration information of a light output state of each of the light output units using any control method provided by the embodiments of the present invention; and a control module for adjusting the light output state of each of the output units based on the configuration information of the light output state.

Correspondingly, the embodiments of the present invention further provide a device, including at least one memory and at least one processor, the memory storing one or more computer instructions, wherein the one or more computer instructions are executable by the processor to implement the control method for the light output unit of the movable device or the tracking method for the movable device according to the embodiments of the present invention.

Correspondingly, the embodiments of the present invention further provide a storage medium, the storage medium storing one or more computer instructions, wherein the one or more computer instructions are configured to implement the control method for the light output unit of the movable device or the tracking method for the movable device according to the embodiments of the present invention.

Compared with the prior art, the technical solutions of the embodiments of the present invention have the following advantages:

In the control method for the light output unit of the movable device according to the embodiments of the present invention, the configuration information of the light output states of all the light output units at the next frame time is obtained based on the motion state of the movable device at the next frame time, to control the light output units. Obtaining the light output states of all the light output units at the next frame time based on the motion state of the movable device at the next frame time is conductive to obtaining the light output states corresponding to the light output units according to the prediction of the motion state at the next frame time. That is, it is favorable for adaptively adjusting the light output states of all the light output units based on a real-time state of the movable device, thus causing the light output units to achieve accurate and low-power light output states. This is conductive to ensuring the use accuracy of the movable device and reducing the power consumption of the movable device.

In the tracking method for the movable device according to the embodiments of the present invention, the configuration information of the light output states of all the light output units at the next frame time is obtained based on the motion state of the movable device at the next frame time, to control the light output units. Obtaining the light output states of all the light output units at the next frame time based on the motion state of the movable device at the next frame time is conductive to obtaining the light output states corresponding to the light output units according to the prediction of the motion state at the next frame time. That is, it is favorable for adaptively adjusting the light output states of all the light output units based on a real-time state of the movable device, thus causing the light output units to achieve accurate and low-power light output states. This is conductive to ensuring the use accuracy of the movable device and reducing the power consumption of the movable device.

### BRIEF DESCRIPTION OF THE DRAWINGS

FIG. 1 is a flow chart of an embodiment of a control method for a light output unit of a movable device according to the present invention;

FIG. 2 is a schematic structural diagram of an embodiment of a movable device according to the present invention;

FIG. 3 is a schematic structural diagram of a detector cooperating with an embodiment of the movable device of FIG. 2 according to the present invention;

FIG. 4 is a flow chart of an embodiment of a tracking method for a movable device according to the present invention;

FIG. 5 is a block functional diagram of an embodiment of a control system for a light output unit of a movable device according to the present invention;

FIG. 6 is a block functional diagram of an embodiment of a tracking system for a movable device according to the present invention; and

FIG. 7 is a structural diagram of hardware of a device according to an embodiment of the present invention.

### DETAILED DESCRIPTION

According to the background section, it is difficult to balance the use accuracy of a movable device and the power consumption of the movable device at present.

Handheld controllers are one of the main means for human-computer interaction in a virtual reality device. According to the principles of the handheld controllers, the handheld controllers can be classified into electromagnetic tracking-based handheld controllers, ultrasonic tracking-based handheld controllers, and optical tracking-based handheld controllers. The optical tracking-based handheld controller has become one of the most mainstream handheld controller solutions in a VR scene due to its characteristics of high accuracy, high robustness, and ease of construction.

According to the basic principle of the optical tracking-based handheld controller, spot information of a positioning lamp on the handheld controller is captured through a camera, and position and attitude information of the handheld controller in a three-dimensional space is calculated according to a computer vision algorithm.

Distribution of the positioning lamp on the handheld controller plays a crucial role in the tracking effect. If there are more positioning lamps, the camera will capture more spot information, thereby improving the tracking accuracy and the robustness. Therefore, from the perspective of the tracking accuracy of the handheld controller, the more the positioning lamps, the better. However, as the number of positioning lamps increases, the power consumption of the handheld controller will also correspondingly increase, which will reduce the endurance of the handheld controller, and the increase of the power consumption will also lead to the generation of more heat, which is not conducive to the miniaturization design of the handheld controller. Therefore, from the perspective of power consumption, the fewer the positioning lamps, the better.

At present, the tracking accuracy and the device power consumption often need to be balanced.

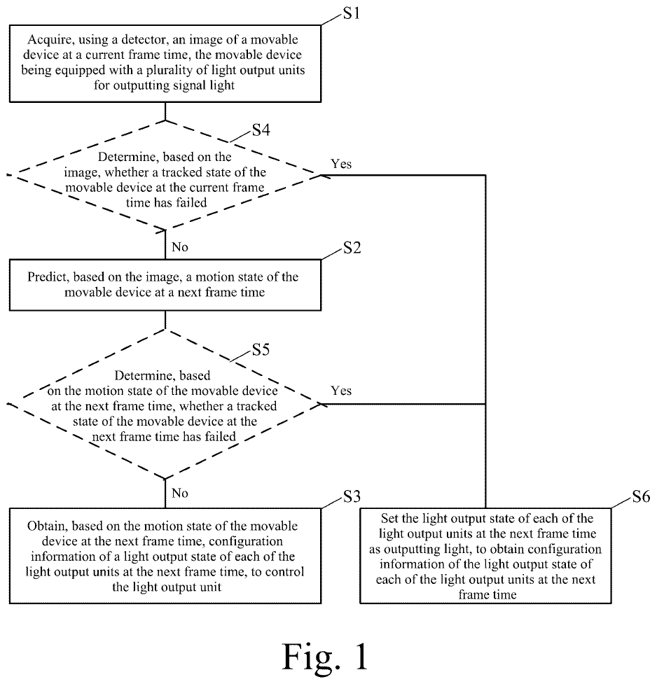

In order to solve the technical problems, the embodiments of the present invention provide a control method for a light output unit of a movable device. Referring to FIG. 1, FIG. 1 is a flow chart of an embodiment of a control method for a light output unit of a movable device according to the present invention.

In the embodiments of the present invention, the control method for the light output unit of the movable device includes the following basic steps:
Step S1: an image of a movable device at a current frame time is acquired using a detector, the movable device being equipped with a plurality of light output units for outputting signal light;
Step S2: a motion state of the movable device at a next frame time is predicted based on the image; and
Step S3: configuration information of a light output state of each of the light output units at the next frame time is obtained based on the motion state of the movable device at the next frame time, to control the light output unit.

In the control method according to the embodiments of the present invention, obtaining the light output states of all the light output units at the next frame time based on the motion state of the movable device at the next frame time is conductive to obtaining the light output states corresponding to the light output units according to the prediction of the motion state at the next frame time. That is, it is favorable for adaptively adjusting the light output states of all the light output units based on a real-time state of the movable device, thus causing the light output units to achieve accurate and low-power light output states. This is conductive to ensuring the use accuracy of the movable device and reducing the power consumption of the movable device.

In order to make the aforementioned objectives, features, and advantages of the embodiments of the present invention more comprehensible, specific embodiments of the present invention are described in detail below in conjunction with the accompanying drawings.

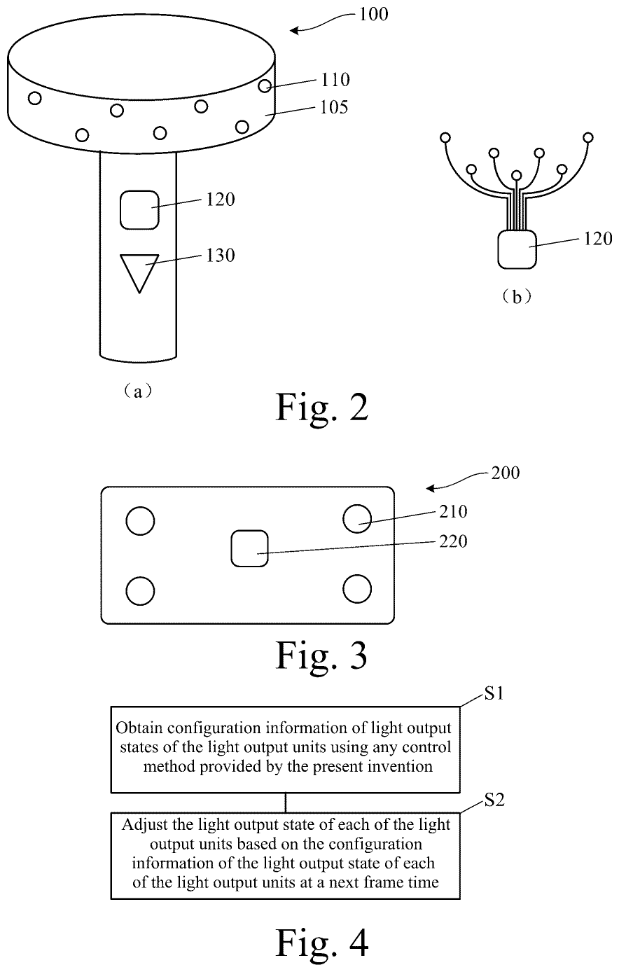

Referring to FIG. 1, combined with FIG. 2 and FIG. 3, FIG. 2 is a schematic structural diagram of an embodiment of a movable device of the present invention, and FIG. 3 is a schematic structural diagram of a detector in conjunction with an embodiment of the movable device in FIG. 2 of the present invention. Step S1 is executed, where an image of a movable device 100 at a current frame time is acquired using a detector 200, the movable device 100 being equipped with a plurality of light output units 110 for outputting signal light.

The movable device 100 is a device that can move and be tracked. The movable device 100 is equipped with the plurality of light output units 110, to extract spots corresponding to the light output units 110 based on the image, thereby obtaining a motion state of the movable device 100.

As an example, the movable device 100 is a handheld controller. For example, the movable device 100 is a handheld controller applied to VR, AR, or MR.

As shown in FIG. 2(a), in a specific embodiment, the handheld controller includes a lamp ring 105, and the plurality of light output units 110 are arranged on the lamp ring 105.

In this embodiment, each light output unit 110 is a positioning lamp. As an example, the positioning lamp can be an infrared LED lamp. The infrared LED lamp will not be detected by human vision and is beneficial for reducing the interference of a working process of the light output unit 110 to the experience of using the movable device 100. In other embodiments, the positioning lamp can also be other types of LED lamps.

In this embodiment, the light output unit 110 outputs light in a flickering mode, which means that the light output unit 110 outputs light in a flickering form. Correspondingly, capturing of the detector 200 is at the same frequency as the flickering of the light output unit 110, and a light output time of the light output unit 110 is synchronized with a capturing time of the detector 200. Therefore, the image of the movable device 100 at the current frame time can be obtained using the detector 200.

In this embodiment, the light output unit 110 adopts the flickering mode, which is conducive to outputting light by the light output unit 110 at intervals to reduce the power consumption of light outputting.

In other embodiments, the light output unit can also output light in a normally on mode, which means that the light output unit always outputs light. Correspondingly, the detector does not need to capture images at the same frequency, and a time for obtaining an image by the detector does not need to be limited.

In this embodiment, the movable device 100 further includes a control module 120 for adjusting light output states of all the light output units 110 based on configuration information of the light output states.

In this embodiment, the light output units 110 are grouped and are connected in parallel, and each group of light output units 110 is connected in series with the control module 120. The light output units 110 in each group are connected in series, or the light output units 110 are connected in parallel. All the light output units are independently connected in series with the control module 120. Therefore, the light output states of all the light output units 110 can be respectively flexibly adjusted based on the configuration information of the light output states of all the light output units 110.

As an example, referring to FIG. 2(b), the light output units 110 are all connected in parallel, and all the output units are independently connected in series with the control module 120.

The detector 200 is configured to capture the image of the movable device 100 at the current frame time to do preparations for extracting the spots corresponding to the light output units 110 and obtaining the motion state of the movable device 100. Correspondingly, the image will be processed subsequently.

In this embodiment, the movable device 100 is used in conjunction with the detector 200. After the motion state of the movable device 100 is obtained, displayed and calculated contents of the detector 200 are updated based on the motion state of the movable device 100. For example, the movable device is a handheld controller applied to VR, AR, or MR, and a detector is a head-mounted display device used in conjunction with the handheld controller. Specifically, the head-mounted display device can be VR, AR, or MR smart glasses.

As an example, referring to FIG. 3, an image acquisition device 210 arranged on the detector 200 can be used to obtain the image of the movable device 100 at the current frame time.

In this embodiment, a plurality of image acquisition devices 210 are used to capture the image of the movable device 100 at the current frame time. As an example, the image acquisition device 210 may include a multi-lens camera, such as a multi-lens infrared camera, thus obtaining images of the infrared LED lamps. Correspondingly, in this embodiment, the image at the current frame time is an image captured by the plurality of image acquisition devices 210, that is, a plurality of images at a frame time are obtained.

The movable device 100 is equipped with the plurality of light output units 110 for outputting signal light. The movable device 100 can be positioned through the signal light output by the light output units 110. Correspondingly, the image includes the spots corresponding to the light output units 110.

Specifically, after the image of the movable device 100 is acquired, the spots corresponding to the signal light output by the light output units 110 can be obtained. Therefore, the image at the current frame time correspondingly contains the spots formed by the signal light. By extracting spot features corresponding to the light output units 110, a current motion state of the movable device 100 at the current frame time can be obtained based on the spot features.

In this embodiment, after an image of a movable device 100 at a current frame time is acquired using a detector, and before a motion state of the movable device 100 at a next frame time is predicted based on the image, the control method further includes: Step S4 is executed, where whether a tracked state of the movable device 100 at the current frame time has failed is determined based on the image; if failed, Step S6 is executed, where the light output state of each of the light output units 110 at the next frame time is set as outputting light, to obtain configuration information of the light output state of each of the light output units 110 at the next frame time; otherwise, the step that a motion state of the movable device 100 at a next frame time is predicted based on the image is executed.

By determining whether the tracked state of the movable device 100 at the current frame time has failed, the image at the current frame time is classified. A next step of calculation processing is only carried out when the tracked state of the movable device 100 at the current frame time has not failed. When the tracked state of the movable device 100 at the current frame time has failed, the next step of calculation processing is not carried out. Instead, the light output state of each of the light output units 110 at the next frame time is directly set, which is conducive to targeted calculation processing, thus saving the computing power.

In this embodiment, when the tracked state of the movable device 100 at the current frame time has failed, the light output state of each of the light output units 110 at the next frame time is set as outputting light, which is beneficial for strengthening positioning information provided by the light output units 110 of the movable device 100 in case of a tracking failure, thereby enabling the tracking of the movable device 100 to be successful as soon as possible.

As an example, a failure in the tracked state of the movable device 100 at the current frame time is usually that the movable device 100 moves out of a field of view. When the movable device 100 moves out of the field of view, the light output state of each of the light output units 110 at the next frame time is set as outputting light, which is beneficial for tracking the movable device 100 for the first time when the movable device moves back into the field of view.

In this embodiment, whether a tracked state of the movable device 100 at the current frame time has failed is determined based on the image, which includes: a number of spots corresponding to the light output units 110 on the image is obtained, wherein the number being less than a preset number of spots indicates that the tracked state of the movable device 100 at the current frame time has failed.

Afterwards, the motion state of the movable device 100 at the next frame time is predicted based on the image, which is achieved by processing the spots, so it is necessary to obtain a sufficient number of spots in order to perform more accurate calculation processing. Therefore, the number of spots corresponding to the light output units 110 on the image is obtained. When the number is less than the preset number of spots, the number of spots is difficult to support the subsequent calculation processing. This indicates that the tracked state of the movable device 100 at the current frame time has failed.

As an example, the preset number of spots is set to be 4.

Continuing with reference to FIG. 1, Step S2 is executed, where a motion state of the movable device 100 at a next frame time is predicted based on the image.

The motion state of the movable device 100 at the next frame time is predicted based on the image, and configuration information of the light output states of the light output units 110 is obtained based on the motion state at the next frame time.

In this embodiment, a motion state of the movable device 100 at a next frame time is predicted based on the image, which includes: a motion state of the movable device 100 at the current frame time is obtained based on the image.

Obtaining the motion state of the movable device 100 at the current frame time is a basis for predicting the motion state of the movable device 100 at the next frame time.

Specifically, in this embodiment, the motion state includes a pose, velocity, and acceleration of the movable device 100.

The pose includes a position and an attitude; the position refers to a degree of freedom of movement (x, y, z) in a coordinate system of the detector 200; the attitude refers to a degree of freedom of rotation (rx, ry, rz) in the coordinate system of the detector 200; the velocity includes a linear velocity and an angular velocity; and the acceleration includes a linear acceleration and an angular acceleration.

In this embodiment, a motion state of the movable device 100 at the current frame time is obtained based on the image, which includes: spots corresponding to the light output units 110 on the image are extracted.

The spots corresponding to the light output units 110 on the image are extracted, so that the pose of the movable device 100 can be obtained based on feature information of the spots subsequently.

In one embodiment, in the process of obtaining, based on the image, the motion state of the movable device 100 at the current frame time, after the spots corresponding to the light output units 110 on the image are extracted, and before the motion state of the movable device 100 at the current frame time is obtained, the control method further includes: the spots are filtered, to filter out abnormally imaged spots.

Filtering the spots facilitates removing abnormal environmental features, which prevents interference caused by the abnormal environmental features on the spot features, thereby improving the accuracy of the feature information of the extracted spot and improving the accuracy of obtaining the pose of the movable device 100 subsequently.

Specifically, as an example, in a practical usage scenario, there are often various environmental lighting interferences such as lighting and natural light. As a result, the detected spot features may not be the spots of the positioning lamps of the movable device. The spots are filtered to remove the abnormal features from the environmental lighting interferences.

As an example, the spots of the positioning lamps usually have high brightness, and the environmental lighting interferences are usually spots with low brightness. By setting a brightness threshold, the spots with the brightness less than the brightness threshold are filtered out, that is, the abnormally imaged spots can be filtered out.

As another example, the spot features of the positioning lamps are usually circular or elliptical of certain sizes, and environmental lighting interferences are usually irregular in shape. The abnormally imaged spots can be filtered out by determining the shapes and sizes of the features.

In one embodiment, a movable device frame is detected based on the image at the current frame time, and the spots corresponding to the light output units 110 are extracted from the movable device frame.

More specifically, the movable device 100 is a handheld controller. Correspondingly, a handheld controller frame is detected based on the image at the current frame time, and the spots are extracted from the handheld controller frame.

In a specific implementation, the spots can be extracted using a computer vision method or a deep learning method. For example, the computer vision method can include: binarizing the image, and then extracting the spots with brightness greater than the preset brightness threshold from the binarized image, as the spots corresponding to the light output units 110.

In this embodiment, the pose of the movable device 100 at the current frame time is obtained based on the spots corresponding to the light output units 110.

Obtaining the pose of the movable device 100 at the current frame time is a basis for predicting the pose of the movable device 100 at the next frame time.

Specifically, in this embodiment, center positions of the spots are extracted based on the spots corresponding to the light output units 110, and the pose of the movable device 100 at the current frame time is calculated based on the center positions of the spots.

As an example, a method of ellipse fitting is used to extract the center position of each spot.

As an example, methods for calculating the pose of movable device 100 at the current frame time include a Perspective-n-Point (PnP) algorithm.

In this embodiment, a velocity of the movable device at the current frame time is obtained by combining a position of the movable device 100 at a previous frame time, a position of the movable device at the current frame time, and a time difference between the previous frame time and the current frame time.

In this embodiment, an acceleration of the movable device at the current frame time is obtained by combining a velocity of the movable device 100 at a previous frame time, a velocity of the movable device at the current frame time, and a time difference between the previous frame time and the current frame time.

The velocity and acceleration of the movable device 100 at the current frame time are obtained to predict a velocity and acceleration of the movable device 100 at the next frame time.

In a specific embodiment, the movable device 100 is equipped with an Inertial Measurement Unit (IMU) for obtaining inertial measurement data, including a velocity and an acceleration, specifically including a linear acceleration and an angular velocity, measured by the IMU. The inertial measurement data, obtained by the IMU, of the movable device 100 at the current frame time and the calculated motion state of the movable device 100 at the current frame time are fused to obtain more accurate data of the motion state of the movable device 100 at the current frame time, and the data is used as basic data for predicting the motion state of the movable device 100 at the next frame time, which is conducive to more accurately predict the motion state of the movable device 100 at the next frame time.

A frame rate of inertial measurement is high, which is beneficial for improving an output frequency of a current pose. Moreover, by fusing the inertial measurement data of the movable device 100 at the current frame time and the calculated motion state of the movable device 100 at the current frame time, it is possible to achieve smooth filtering on the current motion state, thereby reducing an output jitter and outputting a smooth and low-delay motion state.

In one embodiment, an Extended Kalman Filter (EKF) is used for fusion to output the motion state of the movable device 100 at the current frame image time. In some other embodiments, a square root kalman filter can also be used to output the motion state of the movable device 100 at the current frame image time.

In other embodiments, the movable device can also obtain the motion state of the movable device at the next frame time directly based on the calculated motion state of the movable device at the current frame time, without setting an inertial testing unit.

In this embodiment, the motion state of the movable device 100 at the next frame time is predicted according to the motion state of the movable device 100 at the current frame time.

Predicting the motion state of the movable device 100 at the next frame time facilitates obtaining the light output states of the light output units 110 through the motion state of the movable device 100 at the next frame time.

In this embodiment, during the predicting, based on the motion state of the movable device 100 at the current frame time, a motion state of the movable device 100 at a next frame time, the motion state of the movable device 100 at the next frame time is predicted in combination with a motion state of the movable device 100 at the previous frame time and the motion state of the movable device 100 at the current frame time.

Predicting the motion state of the movable device 100 at the next frame time in combination with the motion state of the movable device 100 at the previous frame time and the motion state of the movable device 100 at the current frame time is conductive to enabling the prediction of the motion state of the movable device 100 at the next frame time to be accurate.

In this embodiment, the motion state of the movable device 100 at the next frame time is predicted using the Taylor expansion formula, combined with the motion states of the movable device 100 at both the previous frame time and the current frame time.

Specifically, in this embodiment, if the movable device 100 is set to move at a constant velocity, the acceleration of the movable device 100 is always 0. The velocity of the movable device 100 at the next frame time is equal to the velocity at the current frame time. The position and attitude of the movable device 100 are predicted using a Taylor first-order expansion formula

$$+ 1 = + \frac{( -- 1 )}{Δ - 1} \times Δ ,$$

combined with the motion state of the movable device 100 at the previous frame time and the motion state of the movable device 100 at the current frame time, where +1 is a predicted variable at the next frame time; is a variable calculated at the current frame time; −1 is a variable calculated at the previous frame time; Δ −1 represents a time interval between the previous frame time and the current frame time; and Δ represents a time interval between the current frame time and the next frame time. The variable here includes the position and the attitude.

In other embodiments, the movable device can also be set to move at a uniform acceleration, so that the acceleration of the movable device at the next frame time is equal to the acceleration at the current frame time. The velocity of the movable device is predicted using the Taylor first-order expansion formula, combined with the velocities of the movable device at both the previous frame time and the current frame time. The position and attitude of the movable device are predicted using a Taylor second-order expansion formula, combined with positions and attitudes of the movable device at first two frame times of a current frame and the position and attitude of the movable device at the current frame time.

In some other embodiments, the motion state of the movable device 100 can also be predicted using the Taylor first-order expansion formula

$$+ 1 = + \frac{( - - 1 )}{Δ - 1} \times Δ ,$$

combined with the motion state of the movable device at the previous frame time and the motion state of the movable device at the current frame time, where +1 is a predicted variable at the next frame time; is a variable calculated at the current frame time; −1 is a variable calculated at the previous frame time; Δ −1 represents a time interval between the previous frame time and the current frame time; and Δ represents a time interval between the current frame time and the next frame time. The variable here includes the position, the attitude, the velocity, and the acceleration.

In still some embodiments, the motion state of the movable device at the next frame time can also be predicted in combination with motion states at multiple consecutive frame times prior to the current frame time and the motion state of the movable device at the current frame time.

Correspondingly, in still some embodiments, the motion state of the movable device at the next frame time can also be predicted using the Taylor second-order expansion formula or Taylor expansion formulas at higher orders, combined with motion states at multiple consecutive frame times prior to the current frame time and the motion state of the movable device at the current frame time.

In this embodiment, after a motion state of the movable device 100 at a next frame time is predicted based on the image, and before configuration information of the light output state of each of the light output units 110 at the next frame time is obtained based on the motion state of the movable device 100 at the next frame time, the control method further includes: Step S5 is executed, where whether a tracked state of the movable device 100 at the next frame time has failed is determined based on the motion state of the movable device 100 at the next frame time; if failed, Step S6 is executed, where the light output state of each of the light output units 110 at the next frame time is set as outputting light, to obtain configuration information of the light output state of each of the light output units 110 at the next frame time; otherwise, configuration information of the light output state of each of the light output units 110 at the next frame time is obtained based on the motion state of the movable device 100 at the next frame time.

By determining whether the tracked state of the movable device 100 at the next frame time has failed, the motion state at the next frame time is classified. A next step of calculation processing is only carried out when the tracked state of the movable device 100 at the next frame time has not failed. When the tracked state of the movable device 100 at the next frame time has failed, the next step of calculation processing is not carried out. Instead, the light output state of each of the light output units 110 at the next frame time is directly set, which is conducive to targeted calculation processing, thus saving the computing power.

In this embodiment, when the tracked state of the movable device 100 at the next frame time has failed, the light output state of each of the light output units 110 at the next frame time is set as outputting light, which is beneficial for strengthening positioning information provided by the light output units 110 of the movable device 100 in case of a tracking failure, thereby enabling the tracking of the movable device 100 to be successful as soon as possible.

As an example, a failure in the tracked state of the movable device 100 at the current frame time is usually that the movable device 100 moves out of a field of view. When the movable device 100 moves out of the field of view, the light output state of each of the light output units 110 at the next frame time is set as outputting light, which is beneficial for tracking the movable device 100 for the first time when the movable device moves back into the field of view.

In this embodiment, whether a tracked state of the movable device 100 at the next frame time has failed based on the motion state of the movable device 100 at the next frame time, which includes: whether the velocity or the acceleration of the movable device 100 at the next frame time is abnormal, wherein the velocity or the acceleration being abnormal indicates that the tracked state of the movable device 100 at the next frame time has failed.

When the velocity or the acceleration is abnormal, for example, if the velocity or the acceleration is too large, it indicates that the motion of the movable device 100 at the next frame time is abnormal, thereby indicating that the tracked state of the movable device 100 at the next frame time has failed.

Continuing to refer to FIG. 1, Step S3 is executed, where configuration information of a light output state of each of the light output units 110 at the next frame time is obtained based on the motion state of the movable device 100 at the next frame time, to control the light output unit 110.

In this embodiment, obtaining the light output states of all the light output units 110 at the next frame time based on the motion state of the movable device 100 at the next frame time is conductive to obtaining the light output states corresponding to the light output units 110 according to the prediction of the motion state at the next frame time. That is, it is favorable for adaptively adjusting the light output states of all the light output units 110 based on a real-time state of the movable device 100, thus causing the light output units 110 to achieve accurate and low-power light output states. This is conductive to ensuring the use accuracy of the movable device 100 and reducing the power consumption of the movable device.

In this embodiment, configuration information of a light output state of each of the light output units 110 at the next frame time is obtained based on the motion state of the movable device 100 at the next frame time, which includes: the light output state of each of the light output unit 110 is configured. The configuration includes determining, based on the motion state of the movable device 100 at the next frame time, whether the light output unit 110 is within a detecting range of the detector 200.

Whether the light output unit 110 is within the detecting range of the detector 200 is determined based on the motion state of the movable device 100 at the next frame time. The light output state of the light output unit 110 is set based on whether the light output unit is within the detecting range of the detector 200. Light output units 110 that are not within the detecting range and light output units 110 that are within the detecting range are classified, and the light output states of the light output units 110 are adaptively adjusted based on an actual detection situation.

Specifically, in this embodiment, if the light output unit 110 is not within the detecting range of the detector 200, the light output state of the light output unit 110 is set as not outputting light. Otherwise, the light output state of the light output unit 110 is set as outputting light.

When the light output unit 110 is not within the detecting range of the detector 200, the light output unit 110 is not used during the tracking of the movable device 100 by the detector 200. Correspondingly, setting the light output state of the light output unit 110 as not outputting light is beneficial for saving the light output power consumption and will not affect the tracking accuracy of the detector 200 on the movable device 100.

Otherwise, when the light output unit 110 is within the detecting range of the detector 200, the light output unit 110 needs to be used during the tracking of the movable device 100 by the detector 200. Correspondingly, setting the light output state of the light output unit 110 as outputting light is used for enabling the detector 200 to track the movable device 100.

In this embodiment, the determining, based on the motion state of the movable device at the next frame time, whether the light output unit 110 is within a detecting range of the detector 200 includes: obtaining a pose of each of the light output units 110 on the movable device 100 based on the pose of the movable device 100 at the next frame time; and determining, based on the pose of the light output unit 110, whether the light output unit 110 is within the detecting range of the detector 200.

The pose of the light output unit 110 characterizes a degree of freedom of movement (x, y, z) of the light output unit 110 in a coordinate system of the detector 200, and a degree of freedom of rotation (rx, ry, rz) of the light output unit 110 in the coordinate system of the detector 200. Therefore, whether the light output unit 110 is within the detecting range of the detector 200 can be determined according to the pose of the light output unit 110.

In this embodiment, during the obtaining a pose of each of the light output units 110 on the movable device 100 based on the pose of the movable device 100 at the next frame time, the pose of each of the light output units 110 on the movable device 100 is obtained based on the pose of the movable device 100 at the next frame time and a relative positional relationship between all the light output units 110 on the movable device 100.

Specifically, in this embodiment, each light output unit 110 has a fixed relative position on the movable device 100, and the detector 200 has a model of the relative position of the light output unit 110 on the movable device 100. After the pose of the movable device 100 at the next frame time is obtained, the pose of each light output unit 110 on the movable device 100 can be obtained based on the model, in the detector 200, of the relative position of the light output unit 110 on the movable device 100.

In this embodiment, the determining whether the light output unit 110 is within a detecting range of the detector 200 includes: obtaining a light output direction of the light output unit 110, as a first direction; obtaining a direction of the light output unit 110 toward a center of the coordinate system of the detector 200, as a second direction; and obtaining an included angle between the first and second directions.

The light output direction of the light output unit 110 is a direction where the light output unit 110 outputs light. The direction of the light output unit 110 toward the center of the coordinate system of the detector 200 is a direction where the detector 200 receives the light output by the light output unit 110, so that the included angle between the first direction and the second direction can characterize a receiving condition of the light output by the light output unit 110 by the detector 200.

Specifically, in this embodiment, the pose of the light output unit 110 characterizes a degree of freedom of movement (x, y, z) of the light output unit 110 in the coordinate system of the detector 200, and a degree of freedom of rotation (rx, ry, rz) of the light output unit 110 in the coordinate system of the detector 200. Therefore, the direction of the light output unit 110 toward the center of the coordinate system of the detector 200 is obtained based on the position of the light output unit 110, and the light output direction of the light output unit 110 is obtained based on the pose of the light output unit 110, where the center of the coordinate system of the detector 200 is an original point.

In this embodiment, whether the included angle is within an invalid range of view angle is determined, and the invalid range of view angle is a range of view angle beyond a detecting view angle of the detector 200.

Whether the included angle is within the invalid range of view angle is determined, which means that whether the detector 200 can receive the light output by the light output unit 110 is determined.

It should be noted that in this embodiment, the invalid range of view angle should not be too large, that is, a small end value among end values of the invalid range of view angle should not be too small. In an actual detection process of the detector 200, the spots which are obtained by the detector 200 and correspond to the light output units 110 are circular or elliptical, which means that the spot corresponding to each light output units 110 has a region rather than a point. During the calculation of the motion state, the center position of the spot may be obtained, and the pose is calculated based on the center position of the spot. Therefore, the calculated included angle indicates that the center position of the spot of the light output unit 110 cannot be received by the detector 200 (for example, the calculated angle between the light output direction of the light output unit 110 and the direction of the light output unit 110 towards the center of the coordinate system of the detector 200 is 95°), but actually, some regions around the center position of the spot corresponding to the light output unit 110 can still be received by the detector 200. At this time, it should also be determined that the light output unit 110 is not within the invalid range of view angle. Therefore, in order to avoid determining that the light output unit 110 that the detector 200 can detect is within the invalid range of view angle, in this embodiment, the invalid range of view angle should not be too large. That is, a small end value among end values of the invalid range of view angle should not be too small. Therefore, in this embodiment, the invalid range of view angle is 120° to 180°.

Specifically, in this embodiment, if the included angle is within the invalid range of view angle, it is determined that the light output unit 110 is not within the detecting range of the detector. Otherwise, it is determined that the light output unit 110 is within the detecting range of the detector 200.

Specifically, in this embodiment, if the included angle is within the invalid range of view angle, the light output unit 110 is set as not outputting light. If the included angle is not within the invalid range of view angle, the light output unit 110 is set as outputting light.

Correspondingly, the present invention further provides a tracking method for a movable device. FIG. 4 is a flow chart of an embodiment of a tracking method for a movable device according to the present invention.

Referring to FIG. 4, a movable device 100 (as shown in FIG. 2) is equipped with a plurality of light output units 110 (as shown in FIG. 2) for outputting signal light. Step S1 is executed, where configuration information of light output states of the light output units 110 is obtained using any control method provided by the present invention.

Obtaining the configuration information of the light output states of the light output units 110 facilitates subsequent adjustment of the light output states of the light output units 110 using the configuration information.

Specifically, this embodiment obtains the configuration information of the light output states of the light output units 110 in a calculation processing module 220 (as shown in FIG. 3) of the detector 200 (as shown in FIG. 3).

Obtaining light output states of all the light output units 110 at a next frame time based on a motion state of the movable device 100 at a next frame time is conductive to obtaining the light output states corresponding to the light output units 110 according to the prediction of the motion state at the next frame time. That is, it is favorable for adaptively adjusting the light output states of all the light output units 110 based on a real-time state of the movable device 100, thus causing the light output units 110 to achieve accurate and low-power light output states. This is conductive to ensuring the use accuracy of the movable device 100 and reducing the power consumption of the movable device.

Specific descriptions of the movable device 100 and the obtaining of the configuration information of the light output states of the light output units 110 can refer to the relevant descriptions in the aforementioned embodiments, and will not be elaborated here.

Continuing to refer to FIG. 4, the light output states of all the light output units 110 are adjusted based on the configuration information of the light output states.

In this embodiment, each light output unit 110 adopts a flickering mode, which is conducive to outputting light by the light output units 110 at intervals to reduce the power consumption of light outputting.

Correspondingly, during the adjustment of the light output states of all the light output units 110, the light output units 110 output light in the flickering mode.

In other embodiments, the light output units can also output light in a normally on mode. Correspondingly, during the adjustment of the light output states of all the light output units, the light output units output light in the normally on mode.

In this embodiment, during the adjustment of the light output states of all the light output units 110, the light output states of the light output units 110 are controlled to not output light by reducing a light output frequency to be 0 or reducing a light output duration of each light outputting to 0.

In this embodiment, the movable device 100 further includes a control module 120 (as shown in FIG. 2) for adjusting the light output states of all the light output units 110 based on the configuration information of the light output states.

In this embodiment, the light output units 110 are grouped and are connected in parallel, and each group of light output units 110 is connected in series with the control module 120. The light output units 110 in each group are connected in series, or the light output units 110 are connected in parallel. All the light output units are independently connected in series with the control module 120. Therefore, the light output states of all the light output units 110 can be respectively flexibly adjusted based on the configuration information of the light output states of all the light output units 110.

As an example, referring to FIG. 2(b), the light output units 110 are all connected in parallel, and all the output units are independently connected in series with the control module 120.

In this embodiment, a circuit connection method for connecting the light output units 110 to the control module 120 includes a rigid circuit board, a flexible circuit board, or a flexible and rigid combined board.

In this embodiment, the movable device 100 further includes an information receiving module 130 (as shown in FIG. 2) for receiving the configuration information of the light output states of all the light output units 110.

Specifically, in this embodiment, the information receiving module 130 receives the configuration information of the light output states of all the light output units 110, and then sends the configuration information to the control module 120. The control module 120 adjusts the light output states of all the light output units 110 based on the configuration information of the light output states of all the light output units 110.

In this embodiment, the information receiving module 130 receives information through Bluetooth, WiFi, or wired transmission.

In this embodiment, the configuration information of the light output states is obtained using the control method described in the foregoing embodiments. Specific descriptions of the configuration information of the light output states can refer to the relevant descriptions in the foregoing embodiments, and will not be elaborated here.

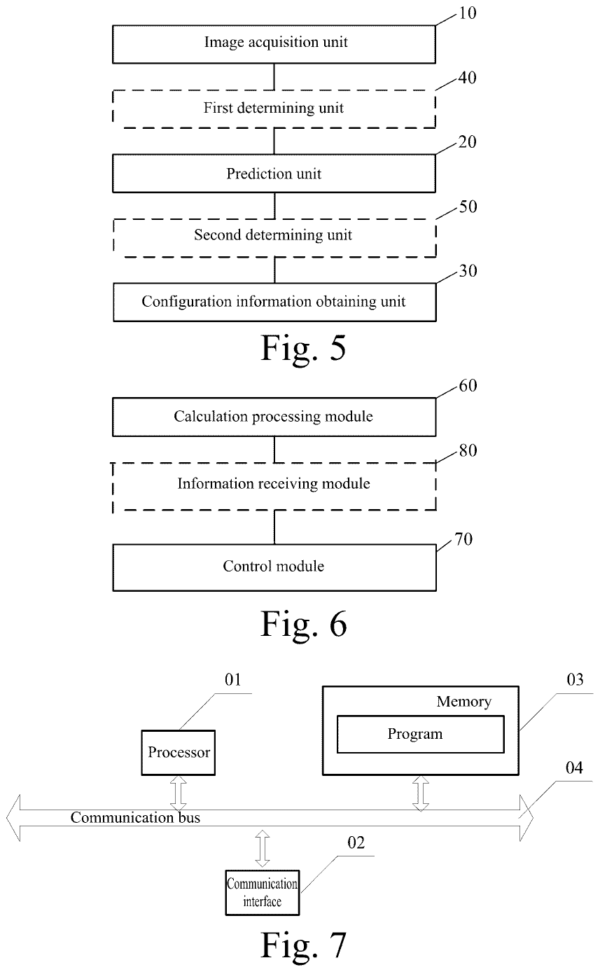

Correspondingly, the present invention further provides a control system for a light output unit of a movable device. FIG. 5 is a block functional diagram of an embodiment of a control system for a light output unit of a movable device according to the present invention.

Referring to FIG. 5, the control system for the light output unit of the movable device includes: an image acquisition unit 10 for acquiring, using a detector, an image of a movable device at a current frame time, wherein the movable device is equipped with a plurality of light output units for outputting signal light; a prediction unit 20 or predicting, based on the image, a motion state of the movable device at a next frame time; a configuration information obtaining unit 30 for obtaining, based on the motion state of the movable device at the next frame time, configuration information of a light output state of each of the light output units at the next frame time, to control the light output unit.

The movable device is a device that can move and be tracked. The movable device is equipped with the plurality of light output units, to extract spots corresponding to the light output units based on the image, thereby obtaining a motion state of the movable device.

As an example, the movable device is a handheld controller. For example, the movable device is a handheld controller applied to VR, AR, or MR.

In a specific embodiment, the handheld controller includes a lamp ring, and the plurality of light output units are arranged on the lamp ring.

In this embodiment, each light output unit is a positioning lamp. As an example, the positioning lamp can be an infrared LED lamp. The infrared LED lamp will not be detected by human vision and is beneficial for reducing the interference of a working process of the light output unit to the experience of using the movable device. In other embodiments, the positioning lamp can also be other types of LED lamps.

In this embodiment, the light output unit outputs light in a flickering mode, which means that the light output unit outputs light in a flickering form. Correspondingly, capturing of the detector is at the same frequency as the flickering of the light output unit, and a light output time of the light output unit is synchronized with a capturing time of the detector. Therefore, the image of the movable device at the current frame time can be obtained using the detector.

In this embodiment, the light output unit adopts the flickering mode, which is conducive to outputting light by the light output unit at intervals to reduce the power consumption of light outputting.

In other embodiments, the light output unit can also output light in a normally on mode, which means that the light output unit always outputs light. Correspondingly, the detector does not need to capture images at the same frequency, and a time for obtaining an image by the detector does not need to be limited.

In this embodiment, the movable device further includes a control module for adjusting light output states of all the light output units based on configuration information of the light output states.

In this embodiment, the light output units are grouped and are connected in parallel, and each group of light output units is connected in series with the control module. The light output units in each group are connected in series, or the light output units are connected in parallel. All the light output units are independently connected in series with the control module. Therefore, the light output states of all the light output units can be respectively flexibly adjusted based on the configuration information of the light output states of all the light output units.

As an example, the light output units are all connected in parallel, and all the output units are independently connected in series with the control module.

The detector is configured to capture the image of the movable device at the current frame time to do preparations for extracting the spots corresponding to the light output units and obtaining the motion state of the movable device. Correspondingly, the image will be processed subsequently.

In this embodiment, the movable device is used in conjunction with the detector. After the motion state of the movable device is obtained, displayed and calculated contents of the detector are updated based on the motion state of the movable device. For example, the movable device is a handheld controller applied to VR, AR, or MR, and a detector is a head-mounted display device used in conjunction with the handheld controller. Specifically, the head-mounted display device can be VR, AR, or MR smart glasses.

As an example, an image acquisition device arranged on the detector can be used to obtain the image of the movable device at the current frame time.

In this embodiment, a plurality of image acquisition devices are used to capture the image of the movable device at the current frame time. As an example, the image acquisition device may include a multi-lens camera, such as a multi-lens infrared camera, thus obtaining images of the infrared LED lamps. Correspondingly, in this embodiment, the image at the current frame time is an image captured by the plurality of image acquisition devices, that is, a plurality of images at a frame time are obtained.

The movable device is equipped with the plurality of light output units for outputting signal light. The movable device can be positioned through the signal light output by the light output units. Correspondingly, the image includes the spots corresponding to the light output units.

Specifically, after the image of the movable device is acquired, the spots corresponding to the signal light output by the light output units can be obtained. Therefore, the image at the current frame time correspondingly contains the spots formed by the signal light. By extracting spot features corresponding to the light output units, a current motion state of the movable device at the current frame time can be obtained based on the spot features.

In this embodiment, the control system further includes: a first determining unit 40 for, after the image of the movable device at the current frame time is acquired using the detector, and before the motion state of the movable device at the next frame time is predicted based on the image, determining, based on the image, whether a tracked state of the movable device at the current frame time has failed; if failed, setting the light output state of each of the light output units at the next frame time as outputting light, to obtain configuration information of the light output state of each of the light output units at the next frame time; otherwise, executing the predicting a motion state of the movable device at a next frame time based on the image.

By determining whether the tracked state of the movable device at the current frame time has failed, the image at the current frame time is classified. A next step of calculation processing is only carried out when the tracked state of the movable device at the current frame time has not failed. When the tracked state of the movable device at the current frame time has failed, the next step of calculation processing is not carried out. Instead, the light output state of each of the light output units at the next frame time is directly set, which is conducive to targeted calculation processing, thus saving the computing power.

In this embodiment, when the tracked state of the movable device at the current frame time has failed, the light output state of each of the light output units at the next frame time is set as outputting light, which is beneficial for strengthening positioning information provided by the light output units of the movable device in case of a tracking failure, thereby enabling the tracking of the movable device to be successful as soon as possible.

As an example, a failure in the tracked state of the movable device at the current frame time is usually that the movable device moves out of a field of view. When the movable device moves out of the field of view, the light output state of each of the light output units at the next frame time is set as outputting light, which is beneficial for tracking the movable device for the first time when the movable device moves back into the field of view.

In this embodiment, the determining, based on the image, whether a tracked state of the movable device at the current frame time has failed includes: obtaining a number of spots corresponding to the light output units on the image, wherein the number being less than a preset number of spots indicates that the tracked state of the movable device at the current frame time has failed.

Afterwards, the motion state of the movable device at the next frame time is predicted based on the image, which is achieved by processing the spots, so it is necessary to obtain a sufficient number of spots in order to perform more accurate calculation processing. Therefore, the number of spots corresponding to the light output units on the image is obtained. When the number is less than the preset number of spots, the number of spots is difficult to support the subsequent calculation processing. This indicates that the tracked state of the movable device at the current frame time has failed.

As an example, the preset number of spots is set to be 4.

The prediction unit 20 is configured for predicting, based on the image, a motion state of the movable device at a next frame time.

The motion state of the movable device at the next frame time is predicted based on the image, and configuration information of the light output states of the light output units is obtained based on the motion state at the next frame time.

In this embodiment, the predicting, based on the image, a motion state of the movable device at a next frame time includes: obtaining, based on the image, a motion state of the movable device at the current frame time.

Obtaining the motion state of the movable device at the current frame time is a basis for predicting the motion state of the movable device at the next frame time.

Specifically, in this embodiment, the motion state includes a pose, velocity, and acceleration of the movable device.

The pose includes a position and an attitude; the position refers to a degree of freedom of movement (x, y, z) in a coordinate system of the detector; the attitude refers to a degree of freedom of rotation (rx, ry, rz) in the coordinate system of the detector; the velocity includes a linear velocity and an angular velocity; and the acceleration includes a linear acceleration and an angular acceleration.

In this embodiment, the obtaining, based on the image, a motion state of the movable device at the current frame time includes: extracting spots corresponding to the light output units on the image.

The spots corresponding to the light output units on the image are extracted, so that the pose of the movable device can be obtained based on feature information of the spots subsequently.

In one embodiment, in the process of obtaining, based on the image, the motion state of the movable device at the current frame time, after the extracting spots corresponding to the light output units on the image, and before the obtaining the motion state of the movable device at the current frame time, the control system is further used for filtering the spots, to filter out abnormally imaged spots.

Filtering the spots facilitates removing abnormal environmental features, which prevents interference caused by the abnormal environmental features on the spot features, thereby improving the accuracy of the feature information of the extracted spot and improving the accuracy of obtaining the pose of the movable device subsequently.

Specifically, as an example, in a practical usage scenario, there are often various environmental lighting interferences such as lighting and natural light. As a result, the detected spot features may not be the spots of the positioning lamps of the movable device. The spots are filtered to remove the abnormal features from the environmental lighting interferences.

As an example, the spots of the positioning lamps usually have high brightness, and the environmental lighting interferences are usually spots with low brightness. By setting a brightness threshold, the spots with the brightness less than the brightness threshold are filtered out, that is, the abnormally imaged spots can be filtered out.

As another example, the spot features of the positioning lamps are usually circular or elliptical of certain sizes, and environmental lighting interferences are usually irregular in shape. The abnormally imaged spots can be filtered out by determining the shapes and sizes of the features.

In one embodiment, a movable device frame is detected based on the image at the current frame time, and the spots corresponding to the light output units are extracted from the movable device frame.

More specifically, the movable device is a handheld controller. Correspondingly, a handheld controller frame is detected based on the image at the current frame time, and the spots are extracted from the handheld controller frame.

In a specific implementation, the spots can be extracted using a computer vision method or a deep learning method. For example, the computer vision method can include: binarizing the image, and then extracting the spots with brightness greater than the preset brightness threshold from the binarized image, as the spots corresponding to the light output units.

In this embodiment, the pose of the movable device at the current frame time is obtained based on the spots corresponding to the light output units.

Obtaining the pose of the movable device at the current frame time is a basis for predicting the pose of the movable device at the next frame time.

Specifically, in this embodiment, center positions of the spots are extracted based on the spots corresponding to the light output units, and the pose of the movable device at the current frame time is calculated based on the center positions of the spots.

As an example, a method of ellipse fitting is used to extract the center position of each spot.

As an example, methods for calculating the pose of movable device at the current frame time include a PnP algorithm.

In this embodiment, a velocity of the movable device at the current frame time is obtained by combining a position of the movable device at a previous frame time, a position of the movable device at the current frame time, and a time difference between the previous frame time and the current frame time.

In this embodiment, an acceleration of the movable device at the current frame time is obtained by combining a velocity of the movable device at a previous frame time, a velocity of the movable device at the current frame time, and a time difference between the previous frame time and the current frame time.

The velocity and acceleration of the movable device at the current frame time are obtained to predict a velocity and acceleration of the movable device at the next frame time.

In a specific embodiment, the movable device is equipped with an IMU for obtaining inertial measurement data, including a velocity and an acceleration, specifically including a linear acceleration and an angular velocity, measured by the IMU. The inertial measurement data, obtained by the IMU, of the movable device at the current frame time and the calculated motion state of the movable device at the current frame time are fused to obtain more accurate data of the motion state of the movable device at the current frame time, and the data is used as basic data for predicting the motion state of the movable device at the next frame time, which is conducive to more accurately predict the motion state of the movable device at the next frame time.

A frame rate of inertial measurement is high, which is beneficial for improving an output frequency of a current pose. Moreover, by fusing the inertial measurement data of the movable device at the current frame time and the calculated motion state of the movable device at the current frame time, it is possible to achieve smooth filtering on the current motion state, thereby reducing an output jitter and outputting a smooth and low-delay motion state.

In one embodiment, an EKF is used for fusion to output the motion state of the movable device at the current frame image time. In some other embodiments, a square root kalman filter can also be used to output the motion state of the movable device at the current frame image time.

In other embodiments, the movable device can also obtain the motion state of the movable device at the next frame time directly based on the calculated motion state of the movable device at the current frame time, without setting an inertial testing unit.

In this embodiment, the motion state of the movable device at the next frame time is predicted according to the motion state of the movable device at the current frame time.

Predicting the motion state of the movable device at the next frame time facilitates obtaining the light output states of the light output units through the motion state of the movable device at the next frame time.

In this embodiment, during the predicting, based on the motion state of the movable device at the current frame time, a motion state of the movable device at a next frame time, the motion state of the movable device at the next frame time is predicted in combination with a motion state of the movable device at the previous frame time and the motion state of the movable device at the current frame time.

Predicting the motion state of the movable device at the next frame time in combination with the motion state of the movable device at the previous frame time and the motion state of the movable device at the current frame time is conductive to enabling the prediction of the motion state of the movable device at the next frame time to be accurate.

In this embodiment, the motion state of the movable device at the next frame time is predicted using the Taylor expansion formula, combined with the motion states of the movable device at both the previous frame time and the current frame time.

Specifically, in this embodiment, if the movable device is set to move at a constant velocity, the acceleration of the movable device 100 is always 0. The velocity of the movable device at the next frame time is equal to the velocity at the current frame time. The position and attitude of the movable device are predicted using a Taylor first-order expansion formula +1=+(− −1)/Δ −1×Δ, combined with the motion state of the movable device at the previous frame time and the motion state of the movable device at the current frame time, where +1 is a predicted variable at the next frame time; is a variable calculated at the current frame time; −1 is a variable calculated at the previous frame time; Δ −1 represents a time interval between the previous frame time and the current frame time; and Δ represents a time interval between the current frame time and the next frame time. The variable here includes the position and the attitude.

In other embodiments, the movable device can also be set to move at a uniform acceleration, so that the acceleration of the movable device at the next frame time is equal to the acceleration at the current frame time. The velocity of the movable device is predicted using the Taylor first-order expansion formula, combined with the velocities of the movable device at both the previous frame time and the current frame time. The position and attitude of the movable device are predicted using a Taylor second-order expansion formula, combined with positions and attitudes of the movable device at first two frame times of a current frame and the position and attitude of the movable device at the current frame time.

In some other embodiments, the motion state of the movable device can also be predicted using the Taylor first-order expansion formula

$$+ 1 = + \frac{( - - 1 )}{Δ - 1} \times Δ ,$$

combined with the motion state of the movable device at the previous frame time and the motion state of the movable device at the current frame time, where +1 is a predicted variable at the next frame time; is a variable calculated at the current frame time; −1 is a variable calculated at the previous frame time; Δ −1 represents a time interval between the previous frame time and the current frame time; and Δ represents a time interval between the current frame time and the next frame time. The variable here includes the position, the attitude, the velocity, and the acceleration.

In still some embodiments, the motion state of the movable device at the next frame time can also be predicted in combination with motion states at multiple consecutive frame times prior to the current frame time and the motion state of the movable device at the current frame time.

Correspondingly, in still some embodiments, the motion state of the movable device at the next frame time can also be predicted using the Taylor second-order expansion formula or Taylor expansion formulas at higher orders, combined with motion states at multiple consecutive frame times prior to the current frame time and the motion state of the movable device at the current frame time.

In this embodiment, the control system further includes: a second determining unit 50 for, after the predicting, based on the image, a motion state of the movable device at a next frame time, and before the obtaining, based on the motion state of the movable device at the next frame time, configuration information of the light output state of each of the light output units at the next frame time, determining, based on the motion state of the movable device at the next frame time, whether a tracked state of the movable device at the next frame time has failed; if failed, setting the light output state of each of the light output units at the next frame time as outputting light, to obtain configuration information of the light output state of each of the light output units at the next frame time; otherwise, obtaining, based on the motion state of the movable device at the next frame time, configuration information of the light output state of each of the light output units at the next frame time.

By determining whether the tracked state of the movable device at the next frame time has failed, the motion state at the next frame time is classified. A next step of calculation processing is only carried out when the tracked state of the movable device at the next frame time has not failed. When the tracked state of the movable device at the next frame time has failed, the next step of calculation processing is not carried out. Instead, the light output state of each of the light output units at the next frame time is directly set, which is conducive to targeted calculation processing, thus saving the computing power.

In this embodiment, when the tracked state of the movable device at the next frame time has failed, the light output state of each of the light output units at the next frame time is set as outputting light, which is beneficial for strengthening positioning information provided by the light output units of the movable device in case of a tracking failure, thereby enabling the tracking of the movable device to be successful as soon as possible.

As an example, a failure in the tracked state of the movable device at the current frame time is usually that the movable device moves out of a field of view. When the movable device moves out of the field of view, the light output state of each of the light output units at the next frame time is set as outputting light, which is beneficial for tracking the movable device for the first time when the movable device moves back into the field of view.

In this embodiment, the determining, based on the motion state of the movable device at the next frame time, whether a tracked state of the movable device at the next frame time has failed includes: determining whether the velocity or the acceleration of the movable device at the next frame time is abnormal, wherein the velocity or the acceleration being abnormal indicates that the tracked state of the movable device at the next frame time has failed.

When the velocity or the acceleration is abnormal, for example, if the velocity or the acceleration is too large, it indicates that the motion of the movable device at the next frame time is abnormal, thereby indicating that the tracked state of the movable device at the next frame time has failed.

The configuration information unit 30 is configured for obtaining, based on the motion state of the movable device at the next frame time, configuration information of a light output state of each of the light output units at the next frame time, to control the light output unit.

In this embodiment, obtaining the light output states of all the light output units at the next frame time based on the motion state of the movable device at the next frame time is conductive to obtaining the light output states corresponding to the light output units according to the prediction of the motion state at the next frame time. That is, it is favorable for adaptively adjusting the light output states of all the light output units based on a real-time state of the movable device, thus causing the light output units to achieve accurate and low-power light output states. This is conductive to ensuring the use accuracy of the movable device and reducing the power consumption of the movable device.

In this embodiment, the obtaining, based on the motion state of the movable device at the next frame time, configuration information of a light output state of each of the light output units at the next frame time includes: configuring the light output state of each of the light output unit. The configuration includes determining, based on the motion state of the movable device at the next frame time, whether the light output unit is within a detecting range of the detector.

Whether the light output unit is within the detecting range of the detector is determined based on the motion state of the movable device at the next frame time. The light output state of the light output unit is set based on whether the light output unit is within the detecting range of the detector. Light output units that are not within the detecting range and light output units that are within the detecting range are classified, and the light output states of the light output units are adaptively adjusted based on an actual detection situation.

Specifically, in this embodiment, if the light output unit is not within the detecting range of the detector, the light output state of the light output unit is set as not outputting light. Otherwise, the light output state of the light output unit is set as outputting light.

When the light output unit is not within the detecting range of the detector, the light output unit is not used during the tracking of the movable device by the detector. Correspondingly, setting the light output state of the light output unit as not outputting light is beneficial for saving the light output power consumption and will not affect the tracking accuracy of the detector on the movable device.

Otherwise, when the light output unit is within the detecting range of the detector, the light output unit needs to be used during the tracking of the movable device by the detector. Correspondingly, setting the light output state of the light output unit as outputting light is used for enabling the detector to track the movable device.

In this embodiment, the determining, based on the motion state of the movable device at the next frame time, whether the light output unit is within a detecting range of the detector includes: obtaining a pose of each of the light output units on the movable device based on the pose of the movable device at the next frame time; and determining, based on the pose of the light output unit, whether the light output unit is within the detecting range of the detector.

The pose of the light output unit characterizes a degree of freedom of movement (x, y, z) of the light output unit in a coordinate system of the detector, and a degree of freedom of rotation (rx, ry, rz) of the light output unit in the coordinate system of the detector. Therefore, whether the light output unit is within the detecting range of the detector can be determined according to the pose of the light output unit.

In this embodiment, during the obtaining a pose of each of the light output units on the movable device based on the pose of the movable device at the next frame time, the pose of each of the light output units on the movable device is obtained based on the pose of the movable device at the next frame time and a relative positional relationship between all the light output units on the movable device.

Specifically, in this embodiment, each light output unit has a fixed relative position on the movable device, and the detector has a model of the relative position of the light output unit on the movable device. After the pose of the movable device at the next frame time is obtained, the pose of each light output unit on the movable device can be obtained based on the model, in the detector, of the relative position of the light output unit on the movable device.

In this embodiment, the determining whether the light output unit is within a detecting range of the detector includes: obtaining a light output direction of the light output unit, as a first direction; obtaining a direction of the light output unit toward a center of the coordinate system of the detector, as a second direction; and obtaining an included angle between the first and second directions.

The light output direction of the light output unit is a direction where the light output unit outputs light. The direction of the light output unit toward the center of the coordinate system of the detector is a direction where the detector receives the light output by the light output unit, so that the included angle between the first direction and the second direction can characterize a receiving condition of the light output by the light output unit by the detector.

Specifically, in this embodiment, the pose of the light output unit characterizes a degree of freedom of movement (x, y, z) of the light output unit in the coordinate system of the detector, and a degree of freedom of rotation (rx, ry, rz) of the light output unit in the coordinate system of the detector. Therefore, the direction of the light output unit toward the center of the coordinate system of the detector is obtained based on the position of the light output unit, and the light output direction of the light output unit is obtained based on the pose of the light output unit, where the center of the coordinate system of the detector is an original point.

In this embodiment, whether the included angle is within an invalid range of view angle is determined, and the invalid range of view angle is a range of view angle beyond a detecting view angle of the detector.

Determining whether the included angle is within the invalid range of view angle means determining whether the detector can receive the light output by the light output unit.

It should be noted that in this embodiment, the invalid range of view angle should not be too large, that is, a small end value among end values of the invalid range of view angle should not be too small. In an actual detection process of the detector, the spots which are obtained by the detector and correspond to the light output units are circular or elliptical, which means that the spot corresponding to each light output units has a region rather than a point. During the calculation of the motion state, the center position of the spot may be obtained, and the pose is calculated based on the center position of the spot. Therefore, the calculated included angle indicates that the center position of the spot of the light output unit cannot be received by the detector (for example, the calculated angle between the light output direction of the light output unit and the direction of the light output unit towards the center of the coordinate system of the detector is 95°), but actually, some regions around the center position of the spot corresponding to the light output unit can still be received by the detector. At this time, it should also be determined that the light output unit is not within the invalid range of view angle. Therefore, in order to avoid determining that the light output unit that the detector can detect is within the invalid range of view angle, in this embodiment, the invalid range of view angle should not be too large. That is, a small end value among end values of the invalid range of view angle should not be too small. Therefore, in this embodiment, the invalid range of view angle is 120° to 180°.

Specifically, in this embodiment, if the included angle is within the invalid range of view angle, it is determined that the light output unit is not within the detecting range of the detector. Otherwise, it is determined that the light output unit is within the detecting range of the detector.

Specifically, in this embodiment, if the included angle is within the invalid range of view angle, the light output unit is set as not outputting light. If the included angle is not within the invalid range of view angle, the light output unit is set as outputting light.

Correspondingly, the present invention further provides a tracking system for a movable device. FIG. 6 is a block functional diagram of an embodiment of a tracking system for a movable device according to the present invention.

The movable device is equipped with a plurality of light output units for outputting signal light, and the tracking system for the movable device includes: a calculation processing module 60 for obtaining configuration information of a light output state of each of the light output units using any control method provided by the present invention; and a control module 70 for adjusting the light output state of each of the output units based on the configuration information of the light output state.

Obtaining the configuration information of the light output states of the light output units by the calculation processing module 60 facilitates subsequent adjustment of the light output states of the light output units using the configuration information.

Obtaining light output states of all the light output units at a next frame time based on a motion state of the movable device at a next frame time is conductive to obtaining the light output states corresponding to the light output units according to the prediction of the motion state at the next frame time. That is, it is favorable for adaptively adjusting the light output states of all the light output units based on a real-time state of the movable device, thus causing the light output units to achieve accurate and low-power light output states. This is conductive to ensuring the use accuracy of the movable device and reducing the power consumption of the movable device.

Specific descriptions of the movable device and the obtaining of the configuration information of the light output states of the light output units can refer to the relevant descriptions in the aforementioned embodiments, and will not be elaborated here.

The control module 70 is configured for adjusting the light output state of each of the light output units based on the configuration information of the light output state.

In this embodiment, the light output unit adopts the flickering mode, which is conducive to outputting light by the light output unit at intervals to reduce the power consumption of light outputting.

Correspondingly, during the adjustment of the light output states of all the light output units, the light output units output light in the flickering mode.

In other embodiments, the light output units can also output light in a normally on mode. Correspondingly, during the adjustment of the light output states of all the light output units, the light output units output light in the normally on mode.

In this embodiment, during the adjustment of the light output states of all the light output units, the light output states of the light output units are controlled to not output light by reducing a light output frequency to be 0 or reducing a light output duration of each light outputting to 0.

In this embodiment, the light output units are grouped and are connected in parallel, and each group of light output units is connected in series with the control module 70. The light output units in each group are connected in series, or the light output units are connected in parallel. All the light output units are independently connected in series with the control module 70. Therefore, the light output states of all the light output units can be respectively flexibly adjusted based on the configuration information of the light output states of all the light output units.

As an example, the light output units are all connected in parallel, and all the output units are independently connected in series with the control module 70.

In this embodiment, a circuit connection method for connecting the light output units to the control module 70 includes a rigid circuit board, a flexible circuit board, or a flexible and rigid combined board.

In this embodiment, the movable device further includes an information receiving module 80 for receiving the configuration information of the light output states of all the light output units.

Specifically, in this embodiment, the information receiving module 80 receives the configuration information of the light output states of all the light output units, and then sends the configuration information to the control module 70. The control module 70 adjusts the light output states of all the light output units based on the configuration information of the light output states of all the light output units.

In this embodiment, the information receiving module 80 receives information through Bluetooth, WiFi, or wired transmission.

In this embodiment, the configuration information of the light output states is obtained using the control method described in the foregoing embodiments. Specific descriptions of the configuration information of the light output states can refer to the relevant descriptions in the foregoing embodiments, and will not be elaborated here.

Specific descriptions of the tracking system in this embodiment can refer to the corresponding descriptions of the tracking method in the foregoing embodiments. This embodiment will not elaborate it here.

The embodiments of the present invention further provide a device that can achieve the control method provided by the embodiments of the present invention by loading the above-mentioned control method in the form of a program, or can achieve the tracking method provided by the embodiments of the present invention by loading the above-mentioned tracking method in the form of a program.

In this embodiment, the device includes a detector and a movable device. The movable device is a device that can move and be tracked. In specific implementation, the movable device is used in conjunction with the detector. After a motion state of the movable device is obtained, displayed and calculated contents of the detector can be updated based on the motion state of the movable device.

For example, the movable device is a handheld controller applied to VR, AR, or MR, and a detector is a head-mounted display device used in conjunction with the handheld controller. Specifically, as an example, the head-mounted display device can be VR, AR, or MR smart glasses.

Correspondingly, as an example, the device provided by this embodiment is a head-mounted all-in-one machine with a handheld controller. For example, the device is a head-mounted 6DoF all-in-one machine and the like.

FIG. 7 shows a structural diagram of hardware of a device according to an embodiment of the present invention. The device of this embodiment includes: at least one processor 01, at least one network interface 02, at least one memory 03, and at least one communication bus 04.

In this embodiment, there is at least one processor 01, communication interface 02, memory 03, and communication bus 04, and the processor 01, the communication interface 02, and the memory 03 complete mutual communications through the communication bus 04.

Optionally, the communication interface 02 can be an interface of a communication module for network communication, such as an interface of a Global System for Mobile Communications (GSM) module.

Optionally, the processor 01 can be a Central Processing Unit (CPU), an Application Specific Integrated Circuit (ASIC), or one or more integrated circuits that are configured to implement the control method according to the embodiments of the present invention.

Optionally, the memory 03 may include a high-speed Random Access Memory (RAM), and may further include a non-volatile memory, for example, at least one disk memory.

The memory 03 stores one or more computer instructions. The one or more computer instructions are executed by the processor 01 to implement the control method or the tracking method provided by the foregoing embodiments.

It should be noted that the above-mentioned implementation terminal devices may also include other devices (not shown) that may not be essential to the disclosed contents of the embodiments of the present invention. Given that these other devices may not be necessary for understanding the disclosed contents of the embodiments of the present invention, the embodiments of the present invention will introduce them one by one.

The embodiments of the present invention further provide a storage medium. The storage medium stores one or more computer instructions. The one or more computer instructions are configured to implement the control method or the tracking method provided by the foregoing embodiments.

The above implementations of the present invention are a combination of elements and features of the present invention. Unless otherwise stated, the elements or features may be considered selective. Each element or feature can be practiced without being combined with other elements or features. In addition, the implementations of the present invention can be constructed by combining some elements and/or features. An order of operations described in the embodiments of the present invention can be rearranged. Some constructions of any implementation may be included in another implementation and may be replaced by corresponding constructions of another implementation. For those skilled in the art, it is obvious that claims without clear reference to each other in the attached claims can be combined into the implementations of the present invention, or can be used as new claims in modifications after submission of the present application.

The implementations of the present invention can be achieved through various means such as hardware, firmware, software, or a combination thereof. In the hardware configuration means, the methods according to exemplary implementations of the present invention may be implemented by one or more ASICs, Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and the like.

In the firmware or software configuration means, the implementations of the present invention can be implemented in the form of modules, processes, functions, and the like. Software codes can be stored in a memory unit and executed by a processor. The memory unit is located inside or outside the processor and can send data to and receive data from the processor through various known measures.

The above explanations of the disclosed embodiments enable those skilled in the art to implement or use the present invention. The various modifications to these embodiments will be apparent to those skilled in the art, and the general principles defined herein can be implemented in other embodiments without departing from the spirit or scope of the present invention. Thus, the present invention is not limited to these embodiments shown herein, but accords with the broadest scope consistent with the principles and novel features disclosed herein.

Although the embodiments of the present invention are disclosed above, the present invention is not limited to this. Any person skilled in the art can make various changes and modifications without departing from the spirit and scope of the present invention, and the protection scope of the present invention is defined by the appended claims.

1. A control method for a light output unit of a movable device, characterized in comprising:
acquiring, using a detector, an image of a movable device at a current frame time, the movable device being equipped with a plurality of light output units for outputting signal light;
predicting, based on the image, a motion state of the movable device at a next frame time; and
obtaining, based on the motion state of the movable device at the next frame time, configuration information of a light output state of each of the light output units at the next frame time, to control the light output unit.

2. The control method of claim 1, characterized in that,
obtaining, based on the motion state of the movable device at the next frame time, configuration information of light output states of the plurality of light output units at the next frame time comprising:
configuring the light output state of each of the light output units; wherein, the configuring comprising:
determining, based on the motion state of the movable device at the next frame time, whether the light output unit is within a detecting range of the detector;
if the light output unit is not within the detecting range of the detector, setting the light output state of the light output unit to no light output; and
otherwise, setting the light output state of the output unit as outputting light.

3. The control method of claim 2, characterized in that,
in the predicting the motion state of the movable device at the next frame time, the motion state includes a pose of the movable device;
determining, based on the motion state of the movable device at the next frame time, whether the light output unit is within a detecting range of the detector comprising:
obtaining a pose of each light output unit on the movable device based on the pose of the movable device at the next frame time; and
determining, based on the pose of the light output unit, whether the light output unit is within the detecting range of the detector.

4. The control method of claim 3, characterized in that,
in the obtaining a pose of each light output unit on the movable device based on the pose of the movable device at the next frame time, the pose of each light output unit on the movable device is obtained based on the pose of the movable device at the next frame time and relative position relationship, on the movable device, of each of the light output unit.

5. The control method of claim 2 or 3, characterized in that determining whether the light output unit is within the detecting range of the detector comprises:
obtaining a light output direction of the light output unit, as a first direction;
obtaining a direction of the light output unit toward a center of a coordinate system of the detector, as a second direction;
obtaining an included angle between the first and second directions;
determining whether the included angle is within the range of an invalid range of view angle, the invalid range of view angle is a range of view angle beyond a detecting view angle of the detector;
if the included angle is within the invalid range of view angle, determining that the light output unit is not within the detecting range of the detector; and
otherwise, determining that the light output unit is within the detecting range of the detector.

6. The control method of claim 5, characterized in that the invalid range of view angle is 120° to 180°.

7. The control method of claim 1, characterized in that, predicting, based on the image, a motion state of the movable device at a next frame time comprises:
obtaining, based on the image, a motion state of the movable device at the current frame time; and
predicting, based on the motion state of the movable device at the current frame time, the motion state of the movable device at the next frame time.

8. The control method of claim 7, characterized in that, obtaining, based on the image, a motion state of the movable device at the current frame time comprising:
extracting a corresponding spot of the light output unit on the image;
obtaining a pose of the movable device at the current frame time based on the spot corresponding to the light output unit;
a velocity of the movable device at the current frame time is obtained, by combining a position of the movable device at a previous frame time, a position of the movable device at the current frame time, and a time difference between the previous frame time and the current frame time; and
obtaining an acceleration of the movable device at the current frame time, by combining a velocity of the movable device at the previous frame time, a velocity of the movable device at the current frame time, and a time difference between the previous frame time and the current frame time, and
predicting, based on the motion state of the movable device at the current frame time, the motion state of the movable device at the next frame time comprising: predicting a pose, a velocity and an acceleration of the movable device at the next frame time based on the pose, the velocity and the acceleration of the movable device at the current frame time.

9. The control method of claim 7, characterized in that, in the step of predicting, based on the motion state of the movable device at the current frame time, the motion state of the movable device at the next frame time, the motion state of the movable device at the next frame time is predicted by combining the motion state of the movable device at the current frame time and a motion state of the movable device at the previous frame time or motion states of the movable device at multiple consecutive frame times prior to the current frame time.

10. The control method of claim 9, characterized in that the motion state of the movable device at the next frame time is predicted by using a Taylor expansion formula in combination with the motion state of the movable device at the current frame time and the motion state of the movable device at the previous frame time or the motion states of the movable device at multiple consecutive frame times prior to the current frame time.

11. The control method of claim 1, characterized in that, after using a detector to obtain an image of an movable device at the current frame time and before predicting, based on the image, a motion state of the movable device at a next frame time, the method further comprises:
determining, based on the image, whether a tracked state of the movable device at the current frame time has failed;
if failed, setting the light output state of each of the light output unit at the next frame time as outputting light, to obtain the configuration information of the light output state of each light output unit at the next frame time;
otherwise, performing the predicting, based on the image, the motion state of the movable device at the next frame time.

12. The control method of claim 11, characterized in that determining, based on the image, whether a tracked state of the movable device at the current frame time has failed comprising:
obtaining a number of spots corresponding to the light output units on the image, wherein the number being less than a preset number of spots indicates that the tracked state of the movable device at the current frame time has failed, when.

13. The control method of claim 1, characterized in that, after predicting, based on the image, a motion state of the movable device at a next frame time and before obtaining, based on the motion state of the movable device at the next frame time, configuration information of a light output state of each of the light output units at the next frame time, to control the light output unit, the method further comprises:
determining, based on the motion state of the movable device at the next frame time, whether a tracked state of the movable device at the next frame time has failed;
if failed, setting the light output state of each of the light output units at the next frame time as outputting light, to obtain the configuration information of the light output state of each of the light outputting unit at the next frame time;
otherwise, obtaining, based on the motion state of the movable device at the next frame time, the configuration information of the light output state of each of the light output unit at the next frame time.

14. The control method of claim 13, characterized in that the motion state includes a velocity and an acceleration; and determining, based on the motion state of the movable device at the next frame time, whether a tracked state of the movable device at the next frame time has failed comprises:
determining whether the velocity or the acceleration of the movable device at the next frame time is abnormal, wherein the velocity or the acceleration being abnormal indicates that the tracked state of the movable device at the next frame time has failed.

15.-20. (canceled)

21. An apparatus comprising:
a memory; and
a processor coupled to the memory, wherein the processor is configured to:
receive an image of a movable device at a first frame time, wherein the movable device is equipped with a plurality of light output units for outputting signal light;
predict, based on the image, a motion state of the movable device at a second frame time; and
obtain, based on the motion state of the movable device at the second frame time, configuration information of a light output state of each of the light output units at the next frame time, to control the light output unit.

22. The apparatus of claim 21, wherein the processor is configured to:
determine, based on the motion state of the movable device at the second frame time, whether the light output unit is within a detecting range of an image sensor of the apparatus;
if the light output unit is not within the detecting range of the image sensor, setting the light output state of the light output unit to no light output; and
otherwise, setting the light output state of the output unit as outputting light.

23. The apparatus of claim 21, wherein the processor is configured to:
obtain a pose of each light output unit on the movable device based on the pose of the movable device at the second frame time; and
determine, based on the pose of the light output unit, whether the light output unit is within the detecting range of the detector.

24. The apparatus of claim 22, wherein the pose of each light output unit on the movable device is obtained based on the pose of the movable device at the second frame time and relative position relationship, on the movable device, of each of the light output unit.

25. The apparatus of claim 21, wherein the processor is configured to:
obtain, based on the image, a motion state of the movable device at the first frame time; and
predict, based on the motion state of the movable device at the second frame time, the motion state of the movable device at the second frame time.

26. The apparatus of claim 21, wherein the processor is configured to
determine, based on the image, whether a tracked state of the movable device at the first frame time has failed;
if failed, setting the light output state of each of the light output unit at the second frame time as outputting light, to obtain the configuration information of the light output state of each light output unit at the second frame time;
otherwise, performing the predicting, based on the image, the motion state of the movable device at the second frame time.
